(19) United States
(12) Patent Application Publication
(10) Pub. No.: US 2019/0118117 A1
(43) Pub. Date: Apr. 25, 2019

(54) FLOATING WEIR

(71) Applicant: Michael John Misun, Grafton, WI (US)

(72) Inventor: Michael John Misun, Grafton, WI (US)

(21) Appl. No.: 16/124,370

(22) Filed: Sep. 7, 2018

Related U.S. Application Data
(60) Provisional application No. 62/575,916, filed on Oct. 23, 2017.

(51) Int. Cl. B01D 21/00

(52) U.S. Cl. CPC B01D 21/0027; B01D 21/0018

(57) ABSTRACT

A weir including a suction well. The suction well may include a circular base having a suction port. The suction well further includes a cylindrical sidewall upstanding from the base. The cylindrical sidewall includes an upper edge defining an open top end. The cylindrical sidewall further includes a plurality of intake slots formed therethrough. The intake slots have an elongated shape and are vertically disposed relative to the base. A float radially extends from the sidewall. The float has a buoyancy such that the weir floats in a liquid, such as water or other coolants.

### CROSS-REFERENCE TO RELATED APPLICATION

This application claims the benefit of priority of U.S. provisional application No. 62/575,916, filed Oct. 23, 2017, the contents of which are herein incorporated by reference.

### BACKGROUND OF THE INVENTION

The present invention relates to weirs and, more particularly, to a new and unique weir for removing oil or other contaminants.

Weirs are currently used to remove contaminants from the surface of a fluid. Current weirs are made of multiple pieces and typically include trap doors or other moving parts. Foreign debris may get caught in the moving trap doors and other moving parts, rendering them inoperative. Further, creating weirs using separate pieces is expensive and creates weirs that are generally too large to work efficiently.

As can be seen, there is a need for a new and unique weir for removing oil or other contaminants.

### SUMMARY OF THE INVENTION

In one aspect of the present invention, a weir comprises: a suction well comprising a base comprising a suction port, and a cylindrical sidewall upstanding from the base and comprising an upper edge defining an open top end, the cylindrical sidewall comprising a plurality of intake slots formed therethrough, wherein the intake slots comprise an elongated shape and are vertically disposed relative to the base; and a float radially extending from the sidewall, wherein the float comprises a buoyancy such that the weir floats in a liquid.

These and other features, aspects and advantages of the present invention will become better understood with reference to the following drawings, description and claims.

### BRIEF DESCRIPTION OF THE DRAWINGS

FIG. 1 is a top perspective view of an embodiment of the present invention;

FIG. 2 is a bottom perspective view of an embodiment of the present invention;

FIG. 3 is a section view of the present invention, taken along line 3-3 in FIG. 1;

FIG. 4 is a section view of the present invention, taken along line 4-4 in FIG. 1;

FIG. 5 is a section view of the present invention, taken along line 5-5 in FIG. 3;

FIG. 6 is a section view of an embodiment of the present invention shown in use; and

FIG. 7 is a section view of an embodiment of the present invention shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a one-piece floating intake weir utilizing vertical slots and no moving parts produced by additive manufacturing technologies. Because the present invention may be produced by way of additive manufacturing processes, it is possible to integrate the parts of the weir together into one piece. This greatly reduces manufacturing costs associated with both materials and manpower, and also eliminates the costs and lost efficiency due to loss of function of a moving part. The total unit can be made much smaller, while more efficient. Further, the slotted design allows the present invention to work more efficiently, as it draws the surface layer from further away, due to an increase in velocity.

The weir of the present invention easily fits in almost any machine tool. The present invention has a much greater drag on the contaminants that float on the surface of the coolant in the machine and requires little to no maintenance. Since the present invention is one piece, a 3D printer may be used to make it.

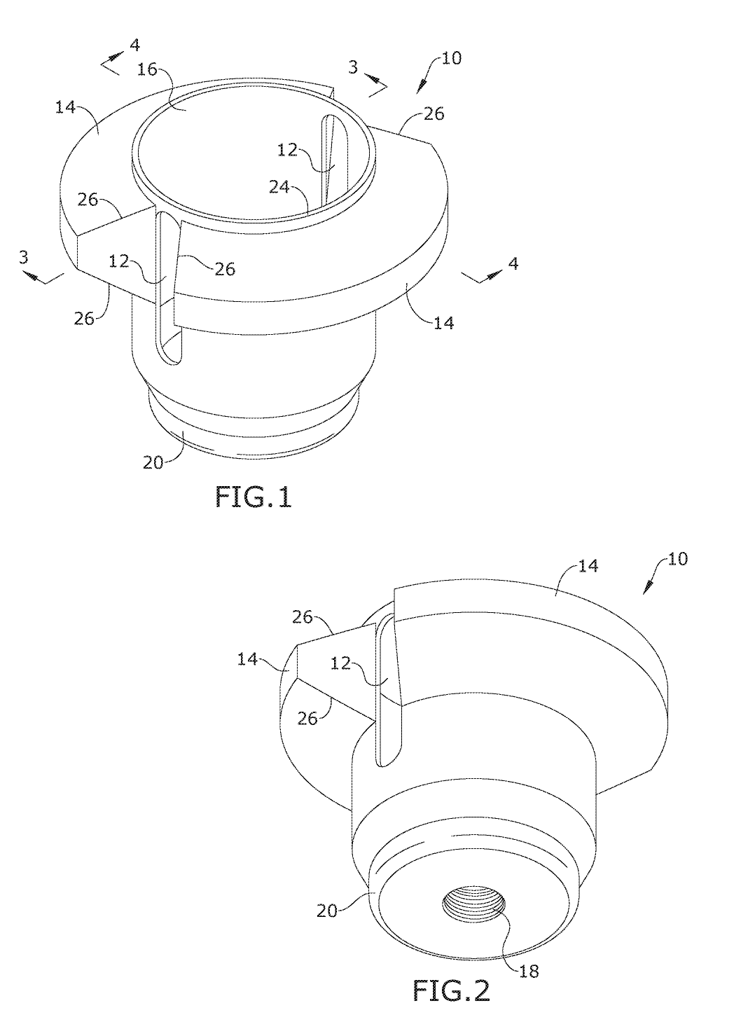

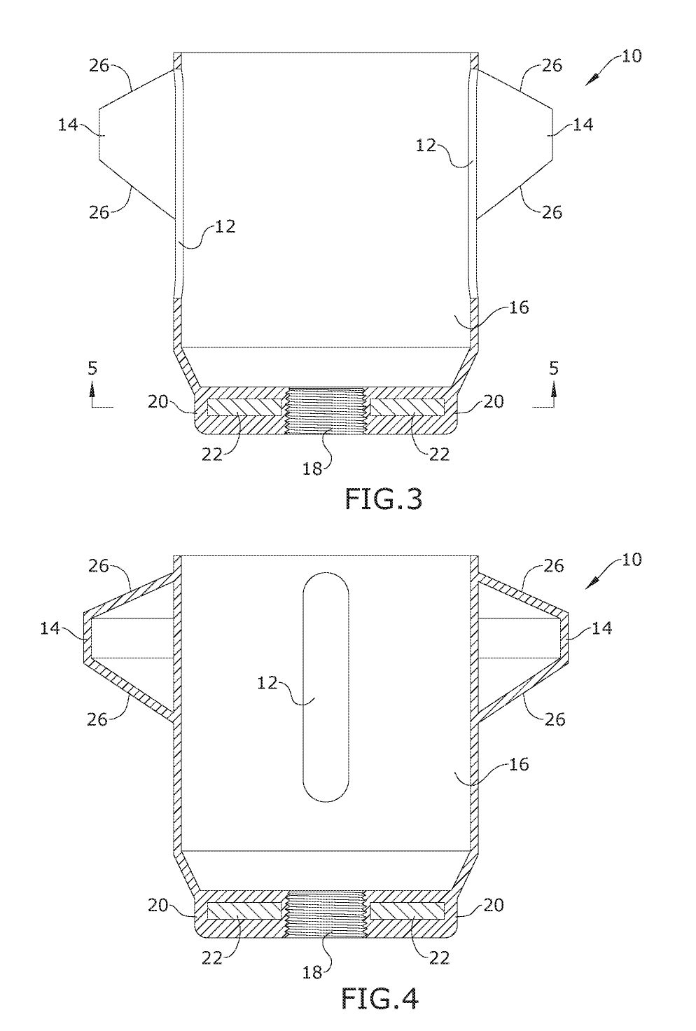

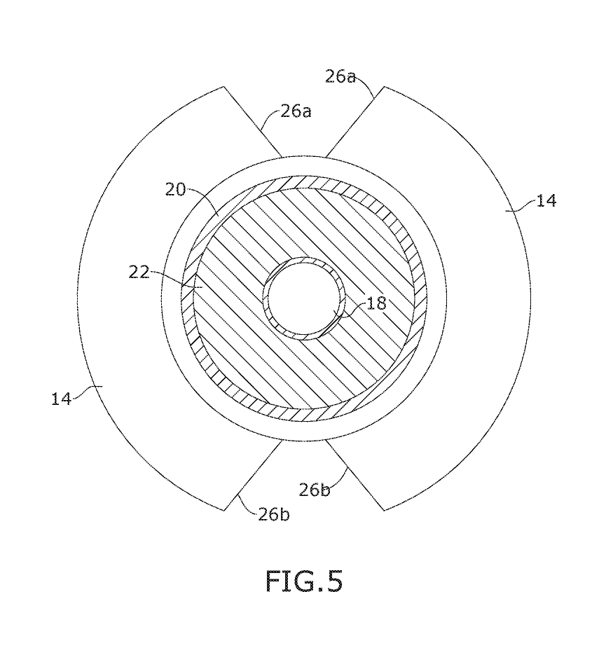

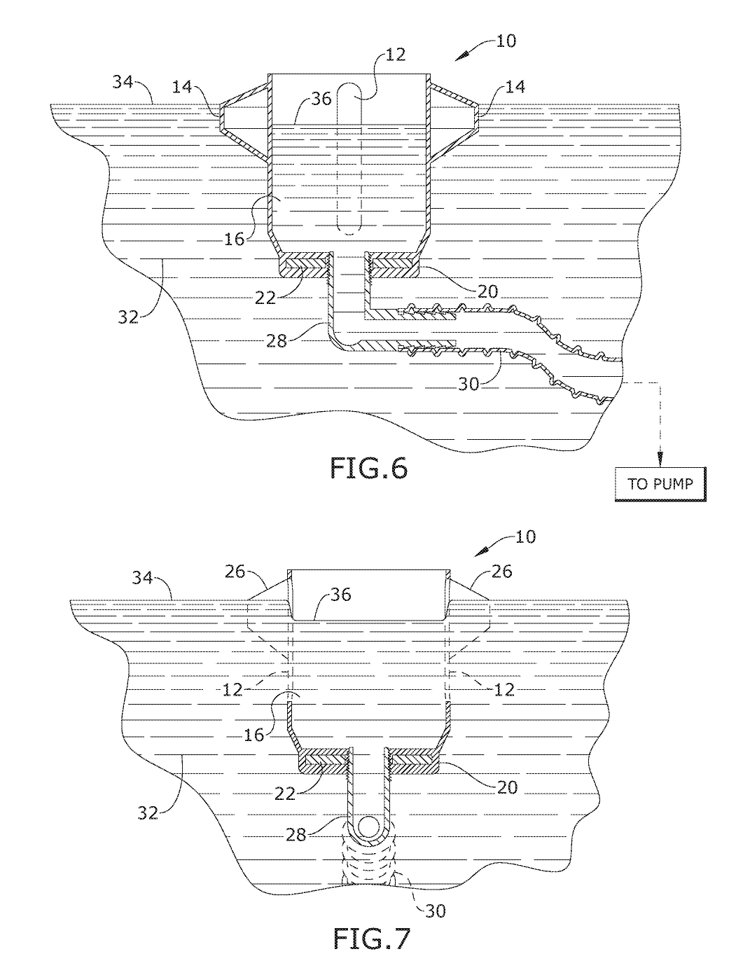

Referring to FIGS. 1 through 7, the present invention includes a weir 10. The weir 10 includes a suction well 16. The suction well 16 may include a circular base having a suction port 18. The suction well 16 further includes a cylindrical sidewall upstanding from the base. The cylindrical sidewall includes an upper edge defining an open top end. The cylindrical sidewall further includes a plurality of intake slots 12 formed therethrough. The intake slots 12 have an elongated shape and are vertically disposed relative to the base. A float 14 radially extends from the sidewall. The float 14 has a buoyancy such that the weir 10 floats in a liquid 32, such as water or other coolants.

In certain embodiments, the float 14 and the suction well 16 are unitary. In such embodiments, the float 14 is made of the same materials as the suction well 16 and is hollow with air sealed within. The float 14 is disposed near the open top end. In certain embodiments, the present invention may include anti-collapse support 24 that includes a lip disposed above the float 14.

The float 14 may include multiple sections each including ends 26. For example, the float 14 may include a first section having a first end 26a and a second end 26b, and a second section having a first end 26a and a second end 26b. A first gap is defined in between the first end 26a of the first section and the first end 26a of the second section, and a second gap is defined in between the second end 26b of the first section and the second end 26b of the second section.

In certain embodiments, the plurality of intake slots 12 include a first intake slot 12 and a second intake slot 12 evenly spaced apart. A top portion of the first intake slot 12 is disposed within the first gap and a top portion of the second intake slot 12 is disposed within the second gap. The first ends 26a include surfaces angled away from one another forming a V-shape and the second ends 26b include surfaces angled away from one another forming a V-shape. The V-shape guides liquid into the suction well 16.

The base may include at least one weight 22 disposed therein. The weight 22 keeps the weir 10 upright when floating in liquid 32. The suction port 18 may include female threads. A threaded fitting 28 mechanically fastens to the suction port 18. A hose 30 is connected to the threaded fitting 28. The hose 30 is connected to a pump. Due to the design of the weir 10, when the pump is turned on, the liquid level 36 within the section well lowers relative to the liquid level 34 outside of the suction port 18. This allows the debris, such as oil, floating on the top of the liquid to flow into the suction well 16. A vortex is created within the suction well 16, removing the debris through the threaded fitting 28 and the hose 30.

The weir 10 is held in suspension in the parent medium by way of the integral floats 14. The weir 10 is held upright by the weights 22 within the base. The cylindrical suction well 16 is initially flooded at the time of insertion, and the medium is drawn from it through the bottom suction port 18. When the level in the suction well 16 drops, the medium increases velocity as it flows past the V shaped float edges and enters the suction well 16 through the vertical intake slots 12. The fluid medium only drops a small amount in this process, and the fluid remaining in the suction well 16 has a tendency of holding back the medium to an extent, and thus, primarily the top layer flows the fastest, gaining speed as it presents with a minor falling action into the weir 10. The upper anti collapse supports 24 are used only as a precaution to give the structure strength.

The present invention may include the following method steps as follows: 1. Insert and thread in a fitting as necessary to allow the invention to be attached to a properly built and sized pump; 2. Attach the unit to said pump suction by way of a proper length of flexible hose; 3. Attach pump discharge to a coalescing unit as necessary; 4. Set pump and weir into the medium where surface skimming and coalescing is required; and 5. Activate the pump.

It should be understood, of course, that the foregoing relates to exemplary embodiments of the invention and that modifications may be made without departing from the spirit and scope of the invention as set forth in the following claims.

What is claimed is:

1. A weir comprising:
a suction well comprising a base comprising a suction port, and a cylindrical sidewall upstanding from the base and comprising an upper edge defining an open top end, the cylindrical sidewall comprising a plurality of intake slots formed therethrough, wherein the intake slots comprise an elongated shape and are vertically disposed relative to the base; and
a float radially extending from the sidewall, wherein the float comprises a buoyancy such that the weir floats in a liquid.

2. The weir of claim 1, wherein the float comprises a first section comprising a first end and a second end, and a second section comprising a first end and a second end, wherein a first gap is defined in between the first end of the first section and the first end of the second section, and a second gap is defined in between the second end of the first section and the second end of the second section.

3. The weir of claim 2, wherein the plurality of intake slots comprises a first intake slot and a second intake slot evenly spaced apart, wherein a top portion of the first intake slot is disposed within the first gap and a top portion of the second intake slot is disposed within the second gap.

4. The weir of claim 3, wherein the first ends comprise surfaces angled away from one another and the second ends comprise surfaces angled away from one another.

5. The weir of claim 1, wherein the float is disposed near the open top end.

6. The weir of claim 5, further comprising an anti-collapse support comprising a lip disposed above the float.

7. The weir of claim 1, wherein the float is unitary with the suction well.

8. The weir of claim 1, wherein the suction port comprises threads.

9. The weir of claim 8, further comprising a threaded fitting mechanically fastened to the suction port.

10. The weir of claim 1, further comprising at least one weight disposed within the base.
